(19) United States
(12) Patent Application Publication
(10) Pub. No.: US 2005/0046290 A1
(43) Pub. Date: Mar. 3, 2005

(54) Actuator

(75) Inventors: Theo Baukholt, Kriftel (DE); Lars Emmel, Hofheim (DE); Erhard Franz, Roedermark (DE); Stefan Pfeiffer, Eppstein (DE); Marcel Rigorth, Babenhausen (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AG, MUNICH (DE)

(21) Appl. No.: 10/740,791

(22) Filed: Dec. 22, 2003

(30) Foreign Application Priority Data
Sep. 1, 2003 (DE) 103 00 641.9

(51) Int. Cl. H02K 7/10; H02K 7/06

(52) U.S. Cl. 310/75 R; 310/83; 475/341; 475/338; 74/665 F

(57) ABSTRACT

The actuator comprises a housing which has a longitudinal axis Z and in which an electric motor having a pinion is arranged. The pinion is in engagement in each case with at least one first gearwheel of a planetary gear, the first gearwheel forming, in each case together with a second gearwheel arranged directly adjacent, a uniform double gearwheel. One or more double gearwheels are arranged here. The first gearwheels run in a first toothed ring, which is connected fixedly to the housing. The respective second gearwheels run in a rotatably mounted, second toothed ring, which is connected to the part which is to be driven, with the number of teeth of the first toothed ring not being identical to the number of teeth of the second toothed ring. The invention furthermore relates to the use of the actuator for actuating a parking brake in a motor vehicle.

### BACKGROUND OF THE INVENTION

The invention is concerned with an actuator and with a use of the actuator. Actuators are known. DE 199 34 161 C2 describes a swashplate mechanism having a shaft mounted in its housing. The gear function is based here essentially on pivoting an axis of a disk, which axis is set at an acute angle with respect to the drive shaft and output shaft, along a lateral area of a cone, so that it executes a wobbling or precision movement. In this case, the swash plate is secured rotatably by means of a double rolling bearing on a hollow cylinder, the axis of which is at the abovementioned, acute-angled inclination with respect to the axis of the supporting drive shaft, on which a hollow cylinder is, for its part, arranged in a rotationally fixed manner. Actuators of this type serve essentially to realize relatively high step-down ratios. A disadvantage of the device described in DE 199 34 161 C2 is that a relatively large structural space has to be provided next to the actual swashplate mechanism for the arrangement of an electric motor, which, in many intended uses, is not needed. Moreover, the arrangement of a double rolling bearing is not always desirable.

### SUMMARY OF THE INVENTION

The invention is therefore based on the object of providing an actuator with which relatively high step-down ratios can be set, with it only being necessary to provide a relatively small lateral structural space. The arrangement of rolling bearings is to be omitted here.

The object on which the invention is based is achieved by an actuator which comprises a housing which has a longitudinal axis Z and in which an electric motor having a pinion is arranged, in which the pinion is in engagement with at least in each case one first gearwheel of a planetary gear, which gearwheel forms, in each case together with a second gearwheel arranged directly adjacent, a uniform double gearwheel, in which the respective first gearwheels run in a first toothed ring, which is connected fixedly to the housing, and the respective second gearwheels run in a rotatably mounted, second toothed ring, which is connected to the part which is to be driven, with the number of teeth of the first toothed ring not being identical to the number of teeth of the second toothed ring. The individual segments of the actuator have a common longitudinal axis Z. The housing is, as a rule, of cup-shaped design and has at least one circular cross section. Each uniform double gearwheel can be manufactured, for example, as an individual part. However, it is also possible in each case to manufacture the first gearwheel and the second gearwheel arranged adjacent as individual parts which then have to be connected to one another. The first toothed ring is connected fixedly to the housing. In one advantageous refinement, it may be possible to manufacture the housing and the first toothed ring likewise as an individual part. This is particularly advantageous if both the first toothed ring and the housing are to be manufactured from a plastic. The number of teeth of the first toothed ring is not identical to the number of the second toothed ring. The two numbers differ, as a rule, by 1 to 4 teeth. The term planetary gear is therefore to be understood to be a differential planetary gear.

It has surprisingly been shown that the actuator can be used to set relatively high step-down ratios, with virtually no lateral structural space being required. This is essentially achieved by an arrangement of housing, electric motor, planetary gear and the toothed rings which is realized on a common longitudinal axis z. Moreover, it is advantageous that the arrangement of rolling bearings can be entirely omitted. The installation can be carried out in a particularly rapid and simple manner if the particular number of teeth of the first toothed ring, of the second toothed ring and of the pinion, which is the sun wheel of the planetary gear, is an integral multiple of the double gearwheels.

One preferred refinement of the invention is that the number of teeth of the first toothed ring differs from the number of teeth of the second toothed ring by 3. This advantageously makes it possible to set relatively high step-up ratios for a wide variety of intended uses.

According to a further preferred refinement of the invention, provision is made for a disk-shaped mounting, which is fixed in the housing and has a central cutout for the pinion and at least one extension, to be arranged between the electric motor and the planetary gear and in which the extension engages in the electric motor. The disk-shaped mounting is, as a rule, a small circular plate with a central hole for the pinion for mounting the electric motor. The mounting is fixed in the housing and engages with its extension in the electric motor. It is advantageous here for the electric motor to have an additional mounting and, at the same time, it is avoided that the electric motor itself is exposed to rotational movements. As a result, the motor mounting can be formed in a simpler manner in terms of construction in the housing on the side lying opposite the pinion.

According to one preferred refinement of the invention, the second gearwheels are connected to each other on their side facing away from the electric motor at their axes of rotation via a bearing element which is in the form of an equilateral triangle. In this case, for example, a plate-like bearing element in the form of a disk can be used as the bearing element. This enables the double gearwheels to be securely mounted, with it being possible to reliably set a constant distance between the axes of rotation of the individual double gearwheels in a relatively simple manner.

According to a further refinement of the invention, provision is made for a total of three double gearwheels to be arranged. This enables a wide variety of step-down ratios to be set in a simple manner in terms of construction, so that the actuator can be used in a particularly versatile manner.

A further preferred refinement of the invention is for the second toothed ring to be part of a cup-shaped wheel which has, in the center of its side facing away from the electric motor, a further extension, which is connected to the part which is to be driven. The design of the second toothed ring as part of a cup-shaped wheel improves the running characteristics of the second toothed ring and therefore the transmission of force to the part which is to be driven.

According to a further preferred refinement of the invention, the number of teeth of the first gearwheel differs from the number of teeth of the directly adjacent, second gearwheel of each double gearwheel. This advantageously provides the possibility of setting relatively large step-down ratios. In this case, for example, a difference in the number of teeth of 1 is sufficient for a wide variety of intended uses.

Finally, the invention also relates to the use of the actuator for actuating a parking brake of a motor vehicle. In this case, it is particularly advantageous that the often disadvantageous arrangement of control cables for the parking brake can be omitted while at the same time optimizing the lateral structural space for the actuator.

### BRIEF DESCRIPTION OF THE SEVERAL VIEWS OF THE DRAWINGS

The invention will be explained in greater detail and by way of example below with reference to the drawing (FIG. 1 to FIG. 4).

FIG. 1 shows a view into the actuator in three-dimensional form.

FIG. 2 shows a design of the actuator in the form of an exploded illustration.

FIG. 3 shows the actuator in cross section.

FIG. 4 shows the arrangement of the planetary gear in the first toothed ring and in the second toothed ring.

### DETAILED DESCRIPTION OF THE INVENTION

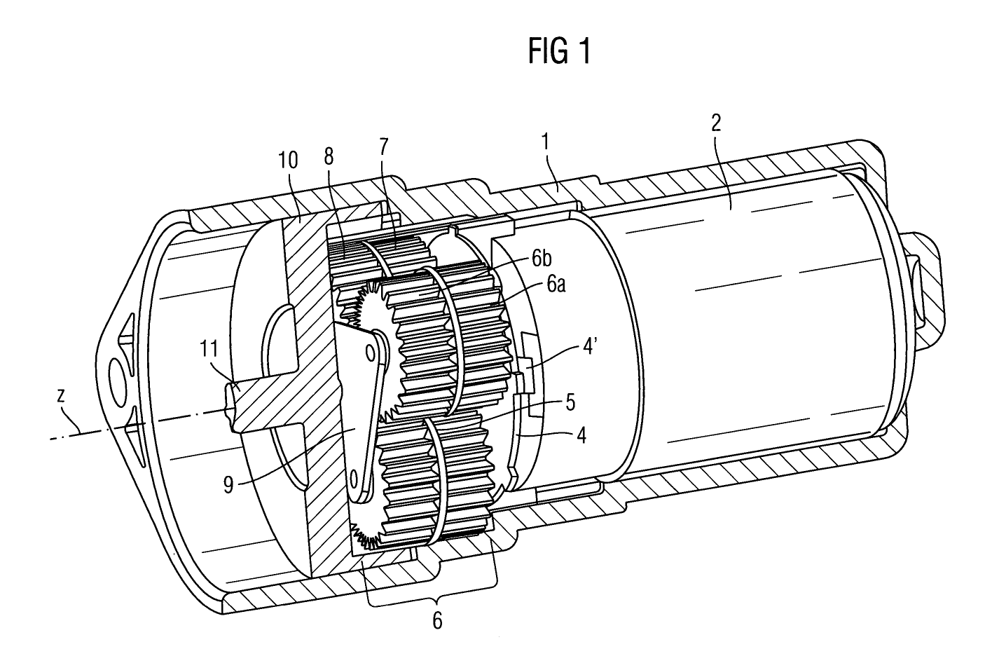

FIG. 1 is a three-dimensional illustration in partial section of one design of the actuator. The actuator comprises a housing 1 which has a longitudinal axis Z and in which an electric motor 2 is arranged. The pinion (not illustrated) of the electric motor 2 is used in each case to engage in a first gearwheel 6a of a planetary gear 5, which gearwheel forms, in each case together with a second gearwheel 6b arranged directly adjacent, a uniform double gearwheel 6. In this case, the double gearwheel 6 may, for example, comprise an individual part. Overall, three double gearwheels 6 are arranged. The respective first gearwheels 6a run in a first toothed ring 7, which constitutes a unit directly with the housing 1. The housing 1 and the first toothed ring 7 are therefore manufactured as an individual part. The respective second gearwheels 6b run in a rotatably mounted, second toothed ring 8, which is part of a cup-shaped wheel 10 which has, in the center of its side facing away from the electric motor 2, a further extension 11, which is connected (not illustrated) to the part which is to be driven. The number of teeth of the first toothed ring 7 is not identical to the number of teeth of the second toothed ring 8, which enables a desired, relatively large step-down ratio to be set. In this case, it is particularly advantageous if the number of teeth of the first toothed ring 7 differs from the number of teeth of the second toothed ring 8 by 3. A disk-shaped mounting 4 which is fixed in the housing 1 and has a central cutout for the pinion (not illustrated) and at least one extension 4′, which engages in the electric motor 2, is arranged between the electric motor 2 and the planetary gear 5. It is also possible to mount the electric motor 2 in the housing 1 via guide elements. The second gearwheels 6b are connected to each other on their side facing away from the electric motor 2 at their axes of rotation via a bearing element 9. This is of disk-shaped design and is in the form of an equilateral triangle. For further setting of step-down ratios, it is particularly advantageous if the number of teeth of the first gearwheel 6a differs from the number of teeth of the directly adjacent, second gearwheel 6b of each double gearwheel 6.

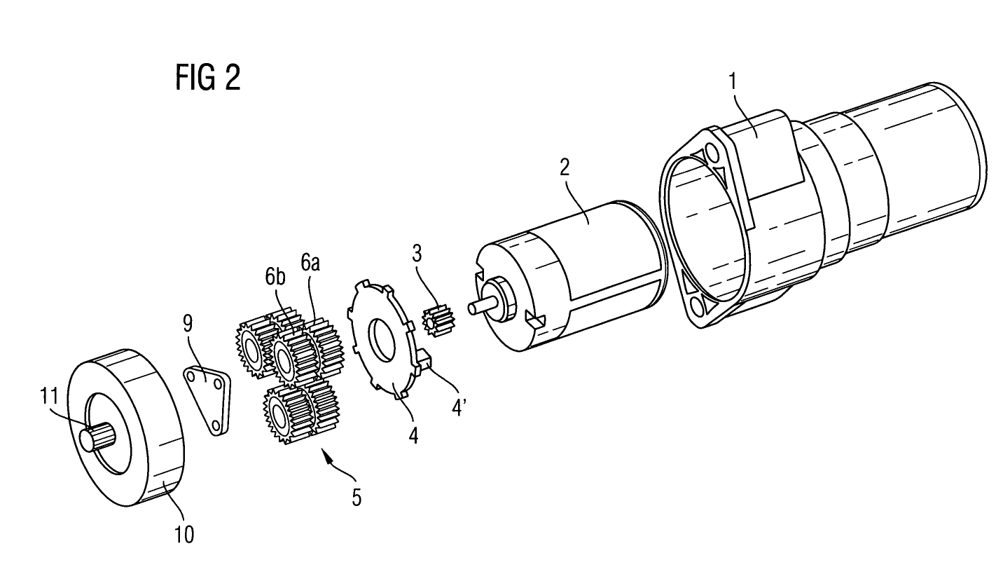

FIG. 2 illustrates the actuator in the form of an exploded drawing in a three-dimensional and simplified manner. In the assembled state, the pinion 3 engages directly in the first gearwheels 6a. A single extension 4′ is arranged in the disk-shaped mounting 4, which is fixed in the housing 1, said extension, in the assembled state, engaging in the electric motor 2 and, by doing so, preventing the electric motor 2 itself from being exposed during operation to a rotational movement.

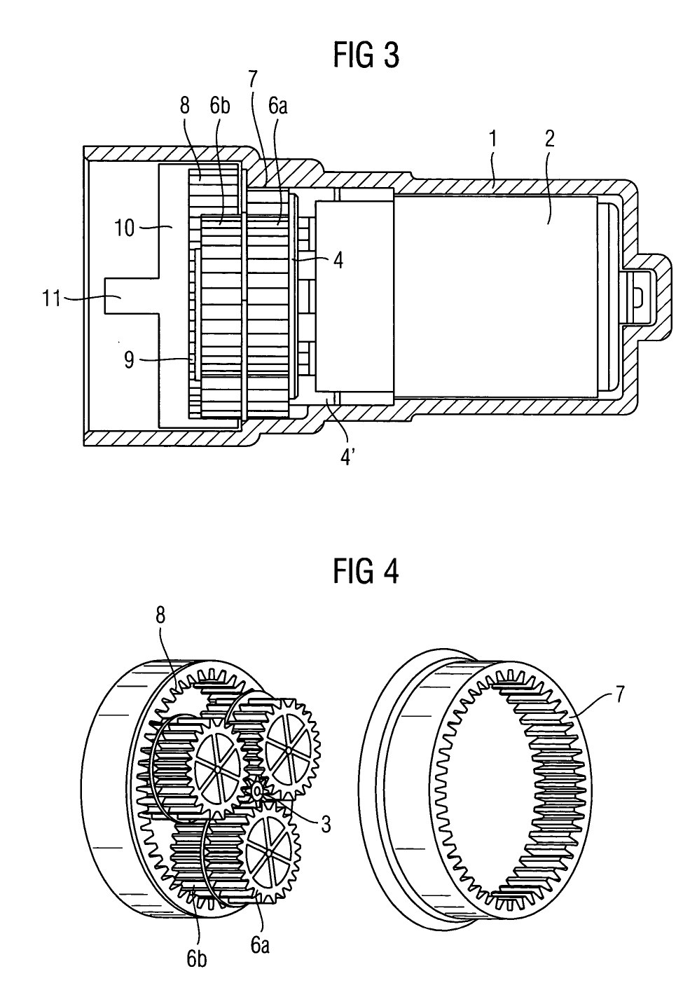

FIG. 3 illustrates the actuator in cross section. The extension 4′ of the disk-shaped mounting 4 engages directly in the electric motor 2.

In FIG. 4, the arrangement of the planetary gear in the second toothed ring 8 is illustrated in a three-dimensional and simplified manner. The pinion 3 of the electric motor (not illustrated) engages in the first gearwheels 6a, which, in the assembled state (not illustrated), run in the first toothed ring 7. The second gearwheels 6b run in the second toothed ring 8, which has a different number of teeth in comparison with the first toothed ring 7. The first toothed ring 7 is manufactured as a separate individual part which has to be placed into the housing 1 and fixed in place.

1. An actuator comprising:
a housing having a longitudinal axis, and
an electric motor arranged with the housing, the motor having a pinion in engagement with at least one first gearwheel of a planetary gear, the first gearwheel case together with a second gearwheel arranged directly adjacent to one another, the first and second gearwheels forming substantially uniform double gearwheel in which the first gearwheels runs, in a first toothed ring the first toothed ring being fixedly_connected to the housing; and the second gearwheels runs in a rotatably mounted second toothed ring (8), the second toothed ring being connected to a part to be driven, wherein a number of teeth of the first toothed ring does not equal a number of teeth of the second toothed ring.

2. The actuator according to claim 1, wherein the number of teeth of the first toothed ring differs from the number of teeth of the second toothed ring by 3.

3. The actuator according to claim 1, further comprising:
disk-shaped mounting fixed in the housing and including a central cutout for the pinion; and
